(19) United States
(12) Patent Application Publication
(10) Pub. No.: US 2013/0282890 A1
(43) Pub. Date: Oct. 24, 2013

(54) IN-STREAM COLLECTION OF ANALYTICS INFORMATION IN A CONTENT DELIVERY SYSTEM

(71) Applicants: Kevin J. Ma, Nashua, NH (US); Jonah Gregory, Milford, MA (US); Raj Nair, Lexington, MA (US)

(72) Inventors: Kevin J. Ma, Nashua, NH (US); Jonah Gregory, Milford, MA (US); Raj Nair, Lexington, MA (US)

(73) Assignee: AZUKI SYSTEMS, INC., Acton, MA (US)

(21) Appl. No.: 13/450,037

(22) Filed: Apr. 18, 2012

(51) Int. Cl. G06F 15/173

(52) U.S. Cl. 709/224

(57) ABSTRACT

Analytics information is collected in a content delivery network when content requests are received by a content router. Analytics information may be gleaned from uniform resource identifiers, and additional augmented analytics information may be specified by either the client that issued the request or an intermediate network node that proxied the request. The augmented analytics information may be specified in proprietary HTTP header fields. Information collection includes intercepting content requests; correlating URIs with known content assets; associating content requests with session state; extracting downstream node augmented information from the content requests; updating session information in persistent storage; selecting target locations from which to retrieve the content assets; and redirecting the content requests to the target locations.

### BACKGROUND

This invention relates in general to collecting content delivery analytics information and more specifically to collecting analytics for over-the-top (OTT) streaming media delivery.

Analytics information or “analytics” is generally any detailed information pertaining to OTT streaming media delivery, including information pertaining to operation of a content delivery network (CDN) for example. CDN analytics may be collected regarding network addresses of clients accessing particular content or class of content, and the information can be analyzed and used to improve network performance by moving or replicating the content to other location(s) to enable more efficient use of CDN resources. This is only one of myriad uses of CDN analytics.

In one scheme of analytics collection in OTT networks, a client application that retrieves content from a CDN reports analytic information to an external analytics processing system. Such a scheme may be inefficient as well as unreliable, depending as it does on individual client behavior.

### SUMMARY

Methods and apparatus are disclosed for collecting analytics information for content delivered over-the-top (OTT) through a content delivery network (CDN). OTT content delivery typically relies on a segment-based retrieval paradigm using the HTTP protocol. CDNs are often used for OTT content delivery because of effectiveness of their commoditized HTTP infrastructures. CDNs are typically organized hierarchically with content uploaded to an origin server and then distributed to a plurality of edge servers. In order to ensure scalability and reliability, CDNs typically manage and maintain heterogeneous distribution of content among the edge servers. When content requests are received by the CDN, they typically traverse a content request router (RR) in order to select an edge server (referred to herein as a “surrogate”) which both has the content and is not overloaded. In a federated, multi-CDN environment, a CDN exchange may act as a first level RR, which then redirects to an individual CDN RR. Aspects of RRs described herein generally apply equally to CDN exchange RRs and individual CDN RRs.

A method is provided for collecting analytics information when a request is received by a RR. In one embodiment, the analytics information is gleaned from only a request uniform resource identifier (URI) in the request. In another embodiment, additional augmented analytics information may be included in the request either by the client issuing the request or by an intermediate network node that has proxied the request. In one embodiment, the augmented analytics information is specified in proprietary HTTP header fields.

Content request URIs point to individual content files, but analytics may require aggregation at less granular levels. In one embodiment, analytics to be collected are defined by an external content management system (CMS) which specifies URL prefixes identifying content assets and individual content files from which they are composed. In one embodiment, the CMS provides other metadata describing the content asset to indicate what type of analytics to record. In one embodiment, HTTP Live Streaming (HLS) content parameters may be specified such that the content asset is understood to be streaming video and that video playback analytics apply. In another embodiment, Web page content parameters may be specified such that the content asset is understood to be a Web site and that impression and click through analytics apply.

Analytics may be associated with specific sessions of content use or access. In one embodiment, session information is inferred from temporal proximity of requests for a given content asset from a given client. In one embodiment, clients are identified by source IP address. In another embodiment, clients are identified by HTTP cookie headers. In another embodiment, clients are identified by proprietary HTTP headers inserted by the client. In one embodiment, content assets are defined by longest URI prefix match. In one embodiment, temporal proximity is defined base on the content asset metadata. In one embodiment, HLS content parameters include the target segment duration, and the session-defining temporal proximity is a multiple N*S, where N is a segment count (e.g., 6) and S is the segment duration. In another embodiment, Web page content parameters include session cookie information corresponding to separate login sessions.

In one embodiment, analytics information is aggregated on a per-content asset, per-client, per-session basis and stored in persistent storage. In one embodiment, the persistent storage is local storage such as a local disk. In another embodiment, the persistent storage is an external, remote storage device. In another embodiment, the analytics information is exported to a third party analytics processing engine (APE).

In one embodiment, a requested content file may reside in multiple locations. An optimal target location is selected to redirect the request to. In one embodiment, the target location is selected based on a round robin or weighted round robin scheme to evenly distribute load among surrogates. In another embodiment, location information supplied by the client is used to select the surrogate closest to the requesting client. In one embodiment, the request is redirected to the target location using HTTP redirects. In another embodiment, the request is transparently proxied to the target location.

A system is described for implementing a client and server infrastructure in accordance with the disclosed methods. The system includes a RR for intercepting and redirecting content requests, CMS and APE interfaces, intermediate network nodes, and a client for inserting augmented analytics information.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a schematic diagram depicting content and analytics computers interfacing to a content delivery system;

FIG. 2 is a block diagram of a content delivery system;

FIG. 3 is a block diagram of a content router from a hardware perspective;

FIG. 4 is a block diagram of a content router from a functional perspective;

FIG. 5 is a flow diagram showing a method for performing content request interception, analytics collection, and content request redirection.

### DETAILED DESCRIPTION

FIG. 1 is a simplified block diagram depicting a content delivery system (CDS) 10 that provides content such as video, music, etc. to CDS clients 12. As described in more detail below, the content delivery system 10 includes components that collect analytics information and make it available to external users or systems such as one or more analytics servers 14. In the illustrated embodiment, the analytics server(s) 14 are connected via a network (NW) 16 to one or more analytics clients 18 that are users or consumers of collected analytics information. Processing of the analytics information may occur at either or both the analytics server(s) 14 and analytics client(s) 18. Processing generally yields refinement of the raw analytics information as well as creation of more easily usable derived analytics information, such as statistical measures, trends, etc.

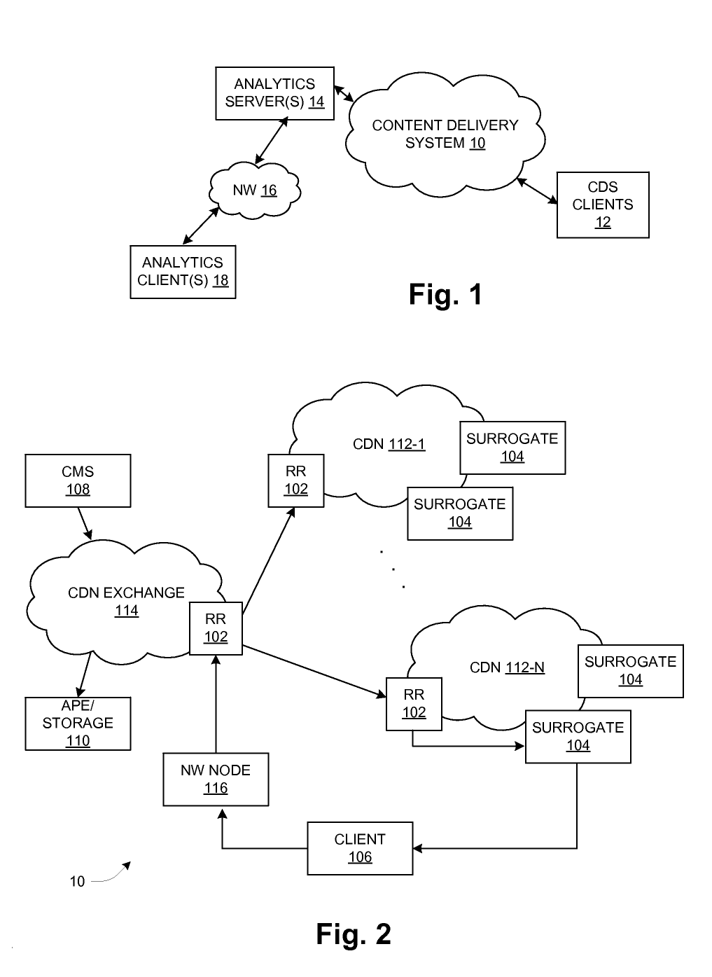

FIG. 2 is a block diagram of a content delivery system 10 for one embodiment of the present invention. Content files reside in CDNs 112 (shown as CDNs 112-1, . . . , 112-N). Each CDN 112 includes one or more request routers (RR) 102 and edge delivery nodes shown as “surrogates” 104. The CDS 10 may also include a CDN exchange 114 used with a federated set of CDNs 112. The CDN exchange 114 also contains one or more RRs 102. A client 106 attaches to the CDN exchange 114 via its RR 102 and perhaps one or more intermediate intelligent network nodes (NW nodes) 116. The CDN exchange 114 has interfaces to a content management system (CMS) 108 and perhaps to an external analytics processing engine (APE) and/or storage 110.

The content management system (CMS) 108 pushes content metadata to the CDN exchange 114. In one embodiment, metadata is transferred using one or more instances of an open interface referred to as the CDN Interconnection (CDNI) Metadata Interface. In another embodiment, metadata is transferred using proprietary interface(s). The metadata is parsed to extract analytics collection configuration information (e.g., URI prefixes, content parameters, etc.) specifying analytics information to be collected. This information is provided to the RR(s) 102 of the CDN exchange 114 for use in collecting the analytics information during operation.

The client 106 issues a content request to the CDN exchange 114. In one embodiment, the client 106 has or obtains information enabling it to contact the CDN exchange 114 directly. In another embodiment, the content request from the client 106 is redirected to the CDN exchange 114 by a separate content router (not shown) performing deep packet inspection and recognizing a content URI signature. The RR 102 matches the content URI in the request to a content asset and records the request information. The RR 102 looks up session information for the client 106. In one embodiment, the client 106 is identified by source IP address. In another embodiment, the client 106 is identified by HTTP cookie headers. In another embodiment, the client 106 is identified by proprietary HTTP headers inserted by the client. In one embodiment, the session is determined based on temporal proximity of requests for component content files of the content asset by the client 106. In one embodiment, HTTP Live Streaming (HLS) content parameters include the target segment duration, and the session proximity is defined as a multiple N*S, where N is a segment count (e.g., 6) and S is the segment duration. In another embodiment, Web page content parameters include session cookie information corresponding to separate login sessions.

In one embodiment, segment-based content retrieval is used, and content segments may be delivered at one of multiple bit rates, providing an ability to dynamically switch between rates of delivery to accommodate network or other conditions. In one embodiment, the RR 102 recognizes HLS content and infers rate switch and session duration analytics from the content request itself. The URI points to a specific segment file for a specific bitrate. That bitrate information may be gleaned from the request. Rate switch analytics may be inferred by comparing bitrate information from the current request to bitrate information from previous requests. Session duration analytics may be inferred by counting requests. The RR 102 also checks to see if the client 106 or any intermediate network nodes 116 have inserted augmented analytics information into the request. The RR 102 extracts and records any augmented analytics information, if it exists, and then directs the request to a CDN 112.

In one embodiment, the client 106 attaches augmented analytics information to the request. In one embodiment, the augmented analytics information is inserted as a proprietary HTTP header. In one embodiment, client bandwidth measurements are included in a proprietary HTTP header (e.g., X-client-bandwidth-estimate) as a number, in bits per second. In one embodiment, network profile information is included in a proprietary HTTP header (e.g., X-client-network) as an enumerated list of valid options (e.g., WiFi, 3G, 4G, etc.). In one embodiment, user playback information for audio/video content is included in a proprietary HTTP header (e.g., X-client-playback-events) as a semi-colon separated list of <event, offset> pairs, where the event comes from an enumerated list of valid options (e.g., play, pause, stop, fast forward, rewind, etc.) and the offset is a time offset (in milliseconds) at which the event occurred in the audio/video stream. In one embodiment, information about rendering errors detected by the client 106 for audio/video content is included in a proprietary HTTP header (e.g., X-client-playback-error) as a semi-colon separated list of <event, offset> pairs, where the event comes from an enumerated list of valid options (e.g., underrun, missing segment, download failure, etc.) and the offset is a time offset in the audio/video stream in milliseconds. In one embodiment, location information is included in a proprietary HTTP header (e.g., X-client-location) as <latitude, longitude, altitude> three-tuple. In one embodiment, round trip latency information for the previous segment request is included in a proprietary HTTP header (e.g., X-client-request-rtt) as a number in milliseconds. In one embodiment, a hash value is provided for each piece of augmented analytics information, one per HTTP header. The final header value is the concatenation of the un-hashed header value and the hash value. In one embodiment, the hash value is generated using the string tuple <header_value, salt>, where the salt is a predetermined shared secret value. There are many hashing algorithms and methods, as should be known to those skilled in the art (e.g., MD5, SHA1, SHA2, etc.). Any of these hashing algorithms and methods would be suitable for use in generating the hash value.

In one embodiment, the request from client 106 passes through one or more intelligent intermediate network nodes 116. In one embodiment, the intermediate network nodes 116 attach augmented analytics information to the request. In one embodiment, the augmented analytics information is inserted as a proprietary HTTP header. In one embodiment, bandwidth availability estimates at the intermediate network node 116 are included in a proprietary HTTP header (e.g., X-network-bandwidth-estimate) as a semi-colon separated list of numbers, in bits per second, where each intermediate network node 116 inserts a new entry (perhaps NULL) at the end of the list to maintain list relativity for all intermediate network node headers. In one embodiment, packet discard rates at the intermediate network node 116 are included in a proprietary HTTP header (e.g., X-network-discard-estimate) as a semi-colon separated list of numbers, in bits per second, where each intermediate network node inserts a new entry (perhaps NULL) at the end of the list to maintain list relativity for all intermediate network node headers. In one embodiment, location information for the intermediate network node 116 is included in a proprietary HTTP header (e.g., X-network-location) as a semi-colon separated list of <latitude, longitude, altitude> three-tuples, where each intermediate network node 116 inserts a new entry (perhaps NULL) at the end of the list to maintain list relativity for all intermediate network node headers. In one embodiment, timestamp information at the intermediate network node 116 is included in a proprietary HTTP header (e.g., X-network-timestamp) as a semi-colon separated list of numbers, in milliseconds offsets from the UNIX epoch, where each intermediate network node inserts a new entry (perhaps NULL) at the end of the list to maintain list relativity for all intermediate network node headers. In one embodiment, a hash value is provided for each piece of augmented analytics information, one per intermediate network node 116, per HTTP header. The per node header value is the concatenation of the un-hashed header value, the intermediate network node ID, and the hash value. The final header value is the semi-colon separated concatenation of all previous intermediate network node header values with the new intermediate network node header value. In one embodiment, the hash value is generated using the string tuple <header_value, node ID, salt>, where the salt is a predetermined shared secret value. There are many hashing algorithms and methods, as should be known to those skilled in the art (e.g., MD5, SHA1, SHA2, etc.). Any of these hashing algorithms and methods would be suitable for use in generating the hash value.

In one embodiment, the intermediate network nodes 116 are each assigned unique node IDs and shared secret values. In another embodiment, the intermediate network nodes 116 are each assigned unique node IDs, but may use duplicate shared secret values, uniformly distributed among the intermediate network nodes 116. In another embodiment, node IDs are assigned based on proximity to the location of a centralized RR 102 (e.g., where the network is arranged as concentric rings, and nodes within a given ring are assigned a node ID relative to the distance of that ring from the center). There are many methods of assigning node IDs, as should be known to those skilled in the art. Mapping node IDs to shared secrets is required for hash verification. Correlation of node paths to physical topology may also be achieved through intelligent node ID allocation algorithms, as should be known to those skilled in the art.

The RR 102 of the CDN exchange 114 determines the available CDNs 112 which contain the requested content file and selects one. In one embodiment, the CDN 112 or surrogate 104 is selected based on a round robin or weighted round robin scheme to evenly distribute load among CDNs 112 or surrogates 104. In another embodiment, location information supplied by the client is used to select the closest CDN 112 or surrogate 104. In one embodiment, the request is redirected to the target location using HTTP redirects. In another embodiment, the request is transparently proxied to the target location. The redirected request is parsed by the individual CDN's RR 102, which selects a surrogate 104. The surrogate 104 returns the requested content file to the client 106.

In one embodiment, the analytics collected by the CDN exchange RR 102 is written to local persistent storage (i.e., disk). In another embodiment, the analytics are exported to a third party 110. In one embodiment, the third party 110 is a remote storage device. In another embodiment, the third party 110 is an external analytics processing engine (APE).

Though the description above applies the analytics collection method to a CDN exchange 114, it should be understood that the same methods may be applied to individual CDNs 112 without loss of generality.

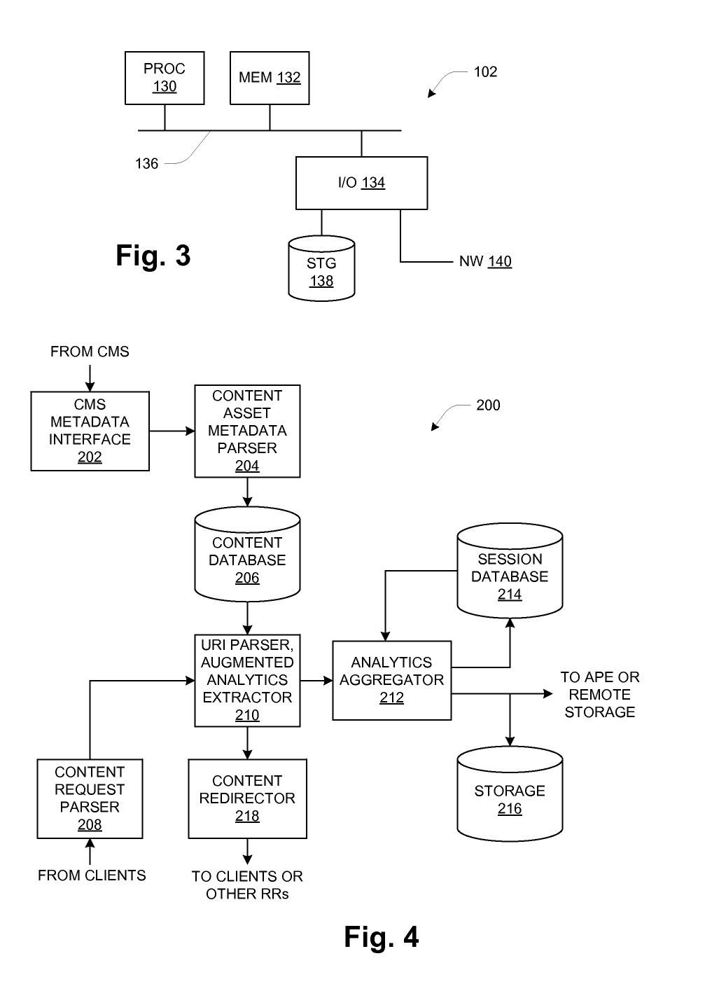

FIG. 3 shows a hardware organization of an RR or content router 102, which is a computerized device generally including instruction processing circuitry (PROC) 130, memory 132, input/output circuitry (I/O) 134, and one or more data buses 136 providing high-speed data connections among these components. The I/O circuitry 134 typically has connections to at least a local storage device (STG) 138 as well as to a network (NW) 140. In operation, the memory 132 includes sets of computer program instructions generally referred to as “programs” or “routines” as known in the art, and these sets of instructions are executed by the processing circuitry 130 to cause the content router 102 to perform certain functions as described herein. It will be appreciated, for example, that in a typical case the structures and functions for analytics collection are realized by corresponding programs executing at the content router 102. Further, the programs may be included in a computer program product which includes a non-transitory computer readable medium storing a set of instructions which, when carried out by a content router 102, cause the content router to perform the methods described herein. Non-limiting examples of such non-transitory computer readable media include magnetic disk or other magnetic data storage media, optical disk or other optical data storage media, non-volatile semiconductor memory such as flash-programmable read-only memory, etc.

FIG. 4 is a block diagram 200 for one embodiment of the present invention for implementing a RR 102 with enhanced analytics collection capabilities. As described above, the RR 102 is typically a computerized device. In operation, the processor 130 executes instructions of one or more computer programs stored in the memory 132 to realize functional units depicted in FIG. 4. For example, the processor 130 when executing instructions of a CMS metadata interface program stored in the memory 132 constitutes a CMS metadata interface 202, etc.

A CMS metadata interface 202 accepts content asset metadata from the CMS 108 (FIG. 2), which is parsed by a content asset metadata parser 204. The content asset metadata parser 204 extracts URI prefix information along with content parameters which enable collection of specific content analytics, and stores that information in a content database 206. The content database 206 does not store content assets themselves, but rather information about content assets that are stored and made available by the CDNs 112 via the surrogates 104. The content asset metadata parser 204 also extracts CDN federation information (e.g., identifications of downstream CDNs that contain the actual content files) and stores that information in the content database 206.

Content requests from the client 106 are received by a content request parser 208. A URI parser and augmented analytics extractor 210 looks up the content asset in the content database 206 and determines which analytics are configured for this content asset. The URI parser and augmented analytics extractor 210 then checks to see if the client 106 or intermediate network node 116 has inserted augmented analytics and if so extracts them from the request. Once it has the content information from the content database 206 and any location information from the client 106 (described below), the URI parser and augmented analytics extractor 210 notifies a content redirector 218 of the downstream CDN 112 or surrogate 104 to which the content request should be directed. The URI parser and augmented analytics extractor 210 also notifies an analytics aggregator 212 once all augmented analytics information has been extracted from the request.

In one embodiment, the client 106 includes augmented analytics information which may include information such as: localized bandwidth estimates, local network connectivity information, user playback information, rendering error information, location information, and/or round trip latency information. In one embodiment, intermediate network nodes 116 include augmented analytics information which may include information such as: localized bandwidth estimates, packet discard rates, location information, and/or timestamp information. In one embodiment, each piece of client 106 augmented analytics information is concatenated with a hash value. The URI parser and augmented analytics extractor 210 verifies the hash using the shared secret for client 106. If the hash does not match, the augmented analytics information is discarded. In one embodiment, each piece of intermediate network node augmented analytics information is concatenated with a node ID and a hash value. The URI parser and augmented analytics extractor 210 verifies the hash using the node ID and the shared secret associated with the node ID. If the hash does not match, the augmented analytics information is discarded.

In one embodiment, the client 106 includes location information in the augmented analytics information. In one embodiment, location information may be in the form of GPS coordinates. In another embodiment, location information may be gleaned from source IP addresses. In another embodiment, location information may be in the form of country code or service provider code.

The analytics aggregator 212 looks up session information in a session database 214 based on the content asset and client information. In one embodiment, the client 106 is identified by source IP address. In another embodiment, the client 106 is identified by HTTP cookie headers. In another embodiment, the client 106 is identified by proprietary HTTP headers inserted by the client. In one embodiment, the session is determined based on temporal proximity of requests for component content files of the content asset by the client 106. In one embodiment, HLS content parameters include the target segment duration, and the session proximity is defined as a multiple N*S, where N is a segment count (e.g., 6) and S is the segment duration. In another embodiment, Web page content parameters include session cookie information corresponding to separate login sessions. If the session is new, the analytics aggregator 212 creates a new session in the session database 214. If the session matches an existing session, the analytics aggregator 212 updates the session state in the session database 214. In one embodiment, the analytics aggregator 212 writes the analytics information to local storage 216. In another embodiment, the analytics aggregator 212 writes the analytics information to a third party 110. In one embodiment, the third party 110 is a remote storage device. In another embodiment, the third party 110 is an external analytics processing engine (APE).

The content redirector 218 uses the downstream CDN 112 and/or surrogate 104 information from the URI parser and augmented analytics extractor 210 to select a target location to which the request should be directed. In one embodiment, the CDN 112 or surrogate 104 is selected based on a round robin or weighted round robin scheme to evenly distribute load among CDNs 112 or surrogates 104. In another embodiment, location information supplied by the client is used to select the closest CDN 112 or surrogate 104. In one embodiment, the request is redirected to the target location using HTTP redirects sent to the client 106. In another embodiment, the request is transparently proxied to the target location.

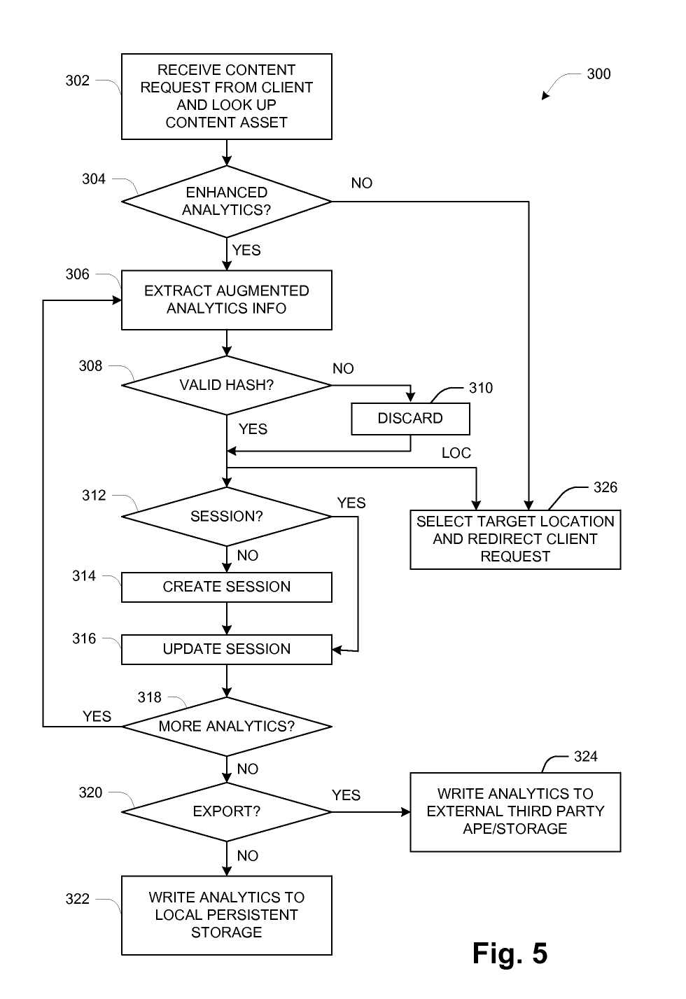

FIG. 5 is a flow chart describing a process 300 for performing content request interception, analytics collection, and content request redirection. In step 302, the content request from client 106 is received by the content request parser 208 and the content asset is looked up in the content database 206 by the URI parser and augmented analytics extractor 210. In step 304, the URI parser and augmented analytics extractor 210 checks to see if enhanced analytics collection is configured. If not, processing proceeds to step 326 where the URI parser and augmented analytics extractor 210 passes downstream CDN 112 and surrogate 104 information to the content redirector 218 which selects a target location to which the content request is redirected. In one embodiment, the CDN 112 or surrogate 104 is selected based on a round robin or weighted round robin scheme to evenly distribute load among CDNs 112 or surrogates 104. In one embodiment, the request is redirected to the target location using HTTP redirects. In another embodiment, the request is transparently proxied to the target location.

If it is determined in step 304 that enhanced analytics collection is configured, processing proceeds to step 306 where the URI parser and augmented analytics extractor 210 extracts a first piece of augmented analytics information from the request. In one embodiment, augmented analytics information is passed via proprietary HTTP headers. In one embodiment, the client 106 includes augmented analytics information which may include information such as: localized bandwidth estimates, local network connectivity information, user playback information, rendering error information, location information, and/or round trip latency information. In one embodiment, intermediate network nodes 116 include augmented analytics information which may include information such as: localized bandwidth estimates, packet discard rates, location information, and/or timestamp information.

In one embodiment, the client 106 includes location information in the augmented analytics information. In one embodiment, location information may be in the form of GPS coordinates. In another embodiment, location information may be gleaned from source IP addresses. In another embodiment, location information may be in the form of country code or service provider code. Such location information, after having its hash validated may also be provided to the content redirector 218 for use in step 326 as described below.

Steps 306-318 describe the procedure for extracting each individual piece of augmented analytics information. In step 306, the first piece of analytics information is extracted. In one embodiment, a hash value (and possibly a node ID) is appended to each piece of augmented analytics information. In step 308, if the hash value is appended, it is verified by the URI parser and augmented analytics extractor 210. In one embodiment, the hash for augmented analytics information from client 106 is salted using the client 106 shared secret. In one embodiment, the hash for augmented analytics information from intermediate network nodes 116 are salted using the intermediate network node 116 shared secret, as identified by the node ID specified with the augmented analytics information. The hashes are verified using the shared secret and known hashing algorithm or method. If the hash value does not match, processing proceeds to step 310 where the unverifiable augmented analytics information is discarded before continuing to step 312. If the hash value matches, processing proceeds directly to step 312. In parallel, if the extracted information is client location information (LOC), processing proceeds to step 326 where the URI parser and augmented analytics extractor 210 passes the location information as well as downstream CDN 112 and surrogate 104 information to the content redirector 218 which selects a target location to which the content request is redirected.

In step 312 the analytics aggregator 212 looks up session information based on the content asset and client 106 information. The content asset information was passed to the analytics aggregator 212 by the URI parser and augmented analytics extractor 210. In one embodiment, the client 106 is identified by source IP address. In another embodiment, the client 106 is identified by HTTP cookie headers. In another embodiment, the client 106 is identified by proprietary HTTP headers inserted by the client. If a session already exists in step 312, processing proceeds to step 316 where the analytics aggregator 212 updates the session information. If the session does not exist in step 312, processing first proceeds to step 314 where a new session is created before continuing on to step 316 where the analytics aggregator 212 updates the session information. If the augmented analytics information was discarded in step 310, the update in step 316 notes the reception of an errant and possibly malicious header value insertion.

Processing then continues to step 318 where the URI parser and augmented analytics extractor 210 checks to see if any further augmented analytics information requires processing. If more augmented analytics information exists, processing proceeds back to step 306 where the next piece of augmented analytics information is extracted. If no further augmented analytics information exists, processing proceeds to step 320 where the analytics aggregator 212 checks to see if analytics export is required. This requirement may be reflected in configuration information included with the content metadata from CMS 108. If analytics export is not required in step 320, then processing proceeds to step 322 where the analytics information is written to local persistent storage (i.e., disk). If analytics export is required in step 320, then processing proceeds to step 324 where the analytics information is exported and sent to a third party 110. In one embodiment, the third party 110 is a remote storage device. In another embodiment, the third party 110 is an external analytics processing engine (APE). In either case, the analytics information may also be stored in local persistent storage.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention. It will be understood by those skilled in the art that various changes in form and details may be made without departing from the scope of the invention as defined by the appended claims.

What is claimed is:

1. A method of operating a content router to collect content distribution analytics in a content delivery system, comprising:
intercepting content requests from client computers and correlating content identifiers in the content requests with known content assets;
redirecting the content requests to selected target locations from which the content assets are delivered in response to the requests; and
extracting downstream-node augmented analytics information from the content requests and making the extracted analytics information available for analytical use;
updating session information and making it available for the analytical use along with the extracted analytics information, the session information relating to content delivery sessions identified based on the content delivery requests and being updated based on the extracted analytics information from the content requests.

2. The method of claim 1, wherein the content assets are composed of multiple content files, and further comprising grouping individual content files to form a single content asset for which analytics are recorded.

3. The method of claim 2, wherein content assets are grouped using a sub-directory structure such that a content asset can be specified by a URI prefix.

4. The method of claim 1, further including obtaining content asset metadata from an external content management system, the content asset metadata describing the analytics to be collected.

5. The method of claim 4, wherein the external content management system controls granularity of analytics collection by specifying content asset uniform resource locator (URL) prefixes.

6. The method of claim 1, wherein the content requests use a secure hypertext transfer protocol (secure HTTP).

7. The method of claim 6, wherein the content requests include augmented analytics information inserted by clients in proprietary HTTP headers, and wherein extracting the downstream node augmented information includes extracting the augmented analytics information from the proprietary HTTP headers.

8. The method of claim 7, wherein the augmented analytics information includes one or more of:
including localized bandwidth measurements from a client;
local network connectivity type from the client;
user interactivity information detected by the client;
rendering errors detected by the client;
current location and mobility information detected by the client; and
round trip latency as detected by the client.

9. The method of claim 8, wherein the user interactivity information includes user activation of video controls controlling one or more of play, pause, stop, rewind, and fast forward functions of a video player.

10. The method of claim 6, wherein the content requests include augmented analytics information inserted by intermediate network nodes in proprietary HTTP headers, and wherein extracting the downstream node augmented information includes extracting the augmented analytics information from the proprietary HTTP headers.

11. The method of claim 10, wherein the augmented analytics information includes one or more of:
localized bandwidth measurements from an intermediate network node;
packet discard rates at the intermediate network node;
current location information for the intermediate network node; and
timestamp for calculating partial round trip latency to the intermediate network node.

12. The method of claim 1, wherein sessions are determined based on at least one of (a) client specified session identifiers as part of the downstream node augmented information, and (b) temporal locality of content requests from a given host for a given content asset.

13. The method of claim 1, further including one or more of storing analytics information in local storage; storing the analytics information in remote storage, and providing the analytics information to a separate analytics processing engine.

14. The method of claim 1, wherein each content file is stored in a plurality of locations and the content management system provides location information identifying all locations from which each content file may be retrieved, and further comprising selecting an optimal location from among the locations to retrieve a requested content file from.

15. The method of claim 14, wherein selecting the optimal location includes using location information provided by the client to select a location closest to the client.

16. The method of claim 14, wherein selecting the optimal location includes using a load balancing scheme to distribute client requests among all locations.

17. The method of claim 1, wherein content requests are redirected using one or both of (a) explicit redirect communications exchanges with clients, and (b) transparent proxying to the locations.

18. The method of claim 1, wherein individual pieces of downstream node augmented information are accompanied by respective hash values to verify the integrity of the information.

19. The method of claim 19, wherein the hash values are generated according to a cryptographic hash function, and further including applying the cryptographic hash function to each individual piece of downstream node augmented information and the respective hash value to verify the integrity of the information.

20. A content router, comprising:
processing circuitry;
memory;
input-output interface circuitry; and
one or more data buses interconnecting the processing circuitry, memory and input-output interface circuitry,
the memory storing computer program instructions which, when executing by the processing circuitry, cause the content router to perform a method of collecting content distribution analytics in a content delivery system including:
intercepting content requests from client computers and correlating content identifiers in the content requests with known content assets;
redirecting the content requests to selected target locations from which the content assets are delivered in response to the requests;
extracting downstream-node augmented analytics information from the content requests and making the extracted analytics information available for analytical use; and
updating session information and making it available for the analytical use along with the extracted analytics information, the session information relating to content delivery sessions identified based on the content delivery requests and being updated based on the extracted analytics information from the content requests.

21. The content router of claim 20, wherein the content assets are composed of multiple content files, and wherein the method further includes grouping individual content files to form a single content asset for which analytics are recorded.

22. The content router of claim 20, wherein the method further includes obtaining content asset metadata from an external content management system, the content asset metadata describing the analytics to be collected.

23. The content router of claim 20, wherein the content requests use a secure hypertext transfer protocol (secure HTTP).

24. The content router of claim 23, wherein the content requests include augmented analytics information inserted by clients in proprietary HTTP headers, and wherein extracting the downstream node augmented information includes extracting the augmented analytics information from the proprietary HTTP headers.

25. The content router of claim 24, wherein the augmented analytics information includes one or more of:
including localized bandwidth measurements from a client;
local network connectivity type from the client;
user interactivity information detected by the client;
rendering errors detected by the client;
current location and mobility information detected by the client; and
round trip latency as detected by the client.

26. The content router of claim 23, wherein the content requests include augmented analytics information inserted by intermediate network nodes in proprietary HTTP headers, and wherein extracting the downstream node augmented information includes extracting the augmented analytics information from the proprietary HTTP headers.

27. The content router of claim 26, wherein the augmented analytics information includes one or more of:
localized bandwidth measurements from an intermediate network node;
packet discard rates at the intermediate network node;
current location information for the intermediate network node; and
timestamp for calculating partial round trip latency to the intermediate network node.

28. The content router of claim 20, wherein sessions are determined based on at least one of (a) client specified session identifiers as part of the downstream node augmented information, and (b) temporal locality of content requests from a given host for a given content asset.

29. A computer program product comprising a non-transitory computer readable medium having computer program instructions stored thereon, the computer program instructions being executable by processing circuitry of a content router to cause the content router to perform a method of collecting content distribution analytics in a content delivery system including:
intercepting content requests from client computers and correlating content identifiers in the content requests with known content assets;
redirecting the content requests to selected target locations from which the content assets are delivered in response to the requests;
extracting downstream-node augmented analytics information from the content requests and making the extracted analytics information available for analytical use; and
updating session information and making it available for the analytical use along with the extracted analytics information, the session information relating to content delivery sessions identified based on the content delivery requests and being updated based on the extracted analytics information from the content requests.

30. The computer program product of claim 29, wherein the content assets are composed of multiple content files, and wherein the method further includes grouping individual content files to form a single content asset for which analytics are recorded.

31. The computer program product of claim 29, wherein the method further includes obtaining content asset metadata from an external content management system, the content asset metadata describing the analytics to be collected.

32. The computer program product of claim 29, wherein the content requests use a secure hypertext transfer protocol (secure HTTP).

33. The computer program product of claim 32, wherein the content requests include augmented analytics information inserted by clients in proprietary HTTP headers, and wherein extracting the downstream node augmented information includes extracting the augmented analytics information from the proprietary HTTP headers.

34. The computer program product of claim 33, wherein the augmented analytics information includes one or more of:
including localized bandwidth measurements from a client;
local network connectivity type from the client;
user interactivity information detected by the client;
rendering errors detected by the client;
current location and mobility information detected by the client; and
round trip latency as detected by the client.

35. The computer program product of claim 32, wherein the content requests include augmented analytics information inserted by intermediate network nodes in proprietary HTTP headers, and wherein extracting the downstream node augmented information includes extracting the augmented analytics information from the proprietary HTTP headers.

36. The computer program product of claim 35, wherein the augmented analytics information includes one or more of:
localized bandwidth measurements from an intermediate network node;
packet discard rates at the intermediate network node;
current location information for the intermediate network node; and
timestamp for calculating partial round trip latency to the intermediate network node.

37. The computer program product of claim 29, wherein sessions are determined based on at least one of (a) client specified session identifiers as part of the downstream node augmented information, and (b) temporal locality of content requests from a given host for a given content asset.
